(19) United States
(12) Patent Application Publication
(10) Pub. No.: US 2021/0073866 A1
(43) Pub. Date: Mar. 11, 2021

(54) INFORMATION PROCESSING APPARATUS, ANALYSIS METHOD, AND NON-TRANSITORY COMPUTER READABLE MEDIUM STORING PROGRAM

(71) Applicant: NEC Corporation, Minato-ku, Tokyo (JP)

(72) Inventor: Takuya SASAKI, Tokyo (JP)

(73) Assignee: NEC Corporation, Minato-ku, Tokyo (JP)

(21) Appl. No.: 16/963,399

(22) PCT Filed: Oct. 26, 2018
(86) PCT No.: PCT/JP2018/039921

§ 371 Date: Jul. 20, 2020

(30) Foreign Application Priority Data
Jan. 22, 2018 (JP) 2018-008050

(51) Int. Cl. G06Q 30/02

(52) U.S. Cl. CPC G06Q 30/0271; G06Q 30/0256; G06Q 30/0261

(57) ABSTRACT

To provide information that serves as a criterion for determining which person in a group consisting of a plurality of persons should be solicited in order to achieve sales more easily. An information processing apparatus (10) includes a data receiving unit (11) that receives group information, the group information being data about a group consisting of, as members, a plurality of persons, an influence information generation unit (12) that analyzes the group information received by the data reception unit (11) and generates influence information, the influence information being data indicating a degree of influence of a member belonging to the group on another member belonging to the group, and data transmission unit (13) that transmits the influence information generated by the influence information generation unit (12) to another apparatus.

### TECHNICAL FIELD

The present invention relates to an information processing apparatus, an analysis method, and a program.

### BACKGROUND ART

The number of foreign visitors to Japan is increasing year by year, and the Japan Tourism Agency aims to have 40 million foreign visitors by 2020. For inbound service providers, sales strategies based on the analyses of inbound markets have become important. Note that the inbound service providers mean all kinds of business operators which may have inbound tourists as their customers, such as those for retailing, accommodations, transportations, and service industries.

In this regard, for example, Patent Literature 1 discloses an information processing apparatus that performs various types of analyses for tax exemption in sales of commodities by using a POS (Point Of Sales) system.

### CITATION LIST

### Patent Literature

Patent Literature 1: Japanese Unexamined Patent Application Publication No. 2017-068365

### SUMMARY OF INVENTION

### Technical Problem

What is important for inbound service providers is not limited to what kinds of commodities are likely to sell well to inbound tourists. Whom they should solicit is also important. There are cases in which even though it is obvious which commodities are likely to sell well, they have little idea whom they should solicit to buy those commodities. For example, when foreign group-tour tourists visiting Japan visit a store all at once, it is difficult to determine whom they should approach to achieve efficient sales of commodities.

Patent Literature 1 discloses an analysis using a POS system, but does not provide any criterion for determining which person in a group consisting of a plurality of persons should be solicited in order to achieve sales more easily.

Therefore, one of the objects that an example embodiment disclosed in this specification is intended to achieve is to provide an information processing apparatus, an analysis method, and a program capable of providing information that serves as a criterion for determining which person in a group consisting of a plurality of persons should be solicited in order to achieve sales more easily.

### Solution to Problem

An information processing apparatus according to a first aspect includes: data receiving means for receiving group information, the group information being data about a group consisting of, as members, a plurality of persons; influence information generation means for generating influence information by analyzing the group information received by the data receiving means, the influence information being data indicating a degree of influence of a member belonging to the group on another member belonging to the group; and data transmitting means for transmitting the influence information generated by the influence information generation means to another apparatus.

In an analysis method according to a second aspect, an information processing apparatus: receives group information, the group information being data about a group consisting of, as members, a plurality of persons; generates influence information by analyzing the received group information, the influence information being data indicating a degree of influence of a member belonging to the group on another member belonging to the group; and transmits the generated influence information to another apparatus.

A program according to a third aspect causes a computer to perform: a data receiving step of receiving group information, the group information being data about a group consisting of, as members, a plurality of persons; an influence information generation step of generating influence information by analyzing the received group information, the influence information being data indicating a degree of influence of a member belonging to the group on another member belonging to the group; and a data transmitting step of transmitting the generated influence information to another apparatus.

### Advantageous Effects of Invention

According to the above-described aspect, it is possible to provide an information processing apparatus, an analysis method, and a program capable of providing information that serves as a criterion for determining which person in a group consisting of a plurality of persons should be solicited in order to achieve sales more easily.

### BRIEF DESCRIPTION OF DRAWINGS

FIG. 1 is a block diagram showing an example of a configuration of an information processing apparatus according to an overview of an example embodiment;

FIG. 2 is a block diagram showing an example of a functional configuration of the information processing apparatus according to the example embodiment;

FIG. 3 is a table showing an example of information generated by a group specifying unit;

FIG. 4 is a table showing evaluation items used by a score calculation unit and examples of scores for respective evaluation items;

FIG. 5 is a table showing an example of a result of calculation of a score for each member by the score calculation unit;

FIG. 6 is a table showing an example of consumption trend information generated by a consumption trend information generation unit;

FIG. 7 is a table showing an example of schedule trend information generated by a schedule trend information generation unit;

FIG. 8 is a flowchart showing an example of operations related to the generation of influence information in an information processing apparatus according to an example embodiment;

FIG. 9 is a flowchart showing an example of operations related to the generation of behavioral trend information in the information processing apparatus according to the example embodiment; and

FIG. 10 is a block diagram showing an example of a hardware configuration of an information processing apparatus according to an example embodiment.

### DESCRIPTION OF EMBODIMENTS

### Overview of Example Embodiment

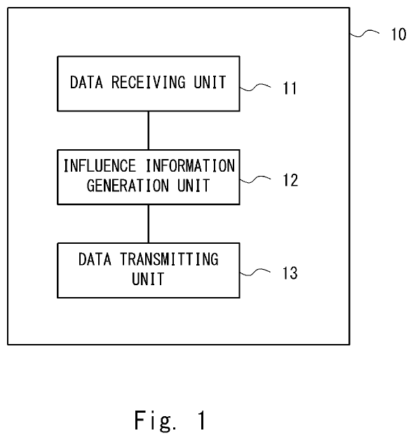

Prior to describing an example embodiment, an overview of an example embodiment according to the present invention will be described. FIG. 1 is a block diagram showing an example of a configuration of an information processing apparatus 10 according to an overview of an example embodiment. The information processor 10 includes a data receiving unit 11, an influence information generation unit 12, and a data transmitting unit 13.

The data receiving unit 11 receives group information. Note that the group information is data about a group consisting of, as members, a plurality of persons. The group information may be any data in which a relation among members belonging to the group is taken into consideration, such as information about a history of communications exchanged between members belonging thereto. The data format of the group information is arbitrarily determined. For example, the group information may be text data, sound data, or image data. Note that the data receiving unit 11 acquires, for example, group information transmitted by a terminal such as a smartphone used by a member belonging to the group through wired or wireless communication. However, the source of the group information is not limited to this example. For example, the data receiving unit 11 may acquire, through wired or wireless communication, group information transmitted from a server of a business operator who provides a communication tool.

The influence information generation unit 12 generates influence information by analyzing the group information received by the data receiving unit 11. Note that the influence information is data indicating a degree of influence of a member belonging to the group on another member(s) belonging to the group. More specifically, the influence information is information associating a degree of influence of at least one member belonging to the group with identification information for identifying the member having that influence. The identification information may be any information by which a member can be identified in the group, and may be, for example, a name, an identifier, a code such as an ID, or information indicating a feature that can be recognized from the appearance of the member.

The data transmitting unit 13 transmits the influence information generated by the influence information generation unit 12 to another apparatus(es). The data transmitting unit 13 transmits the influence information as an index of influence in the group related to the purchase of commodities. Note that the commodity may be a tangible commodity or an intangible commodity such as a service. The data transmitting unit 13 transmits, as the index of the influence in the group related to the purchase of commodities, the influence information to an apparatus of a business operator who provides commodities to customers, such as an inbound service provider, through wire or wireless communication. Note that the other apparatus to which the influence information is transmitted may be an output apparatus such as a display or a printer connected to the information processing apparatus 10.

According to the information processing apparatus 10, the influence information is generated based on the group information. Therefore, information for finding which person in the group has an influence in the group is obtained. That is, it becomes easier to identify an influencer(s) in the group. As described above, according to the information processing apparatus 10, it is possible to provide information that serves as a criterion for determining which person in a group consisting of a plurality of persons should be solicited in order to achieve sales more easily.

### Details of Example Embodiment

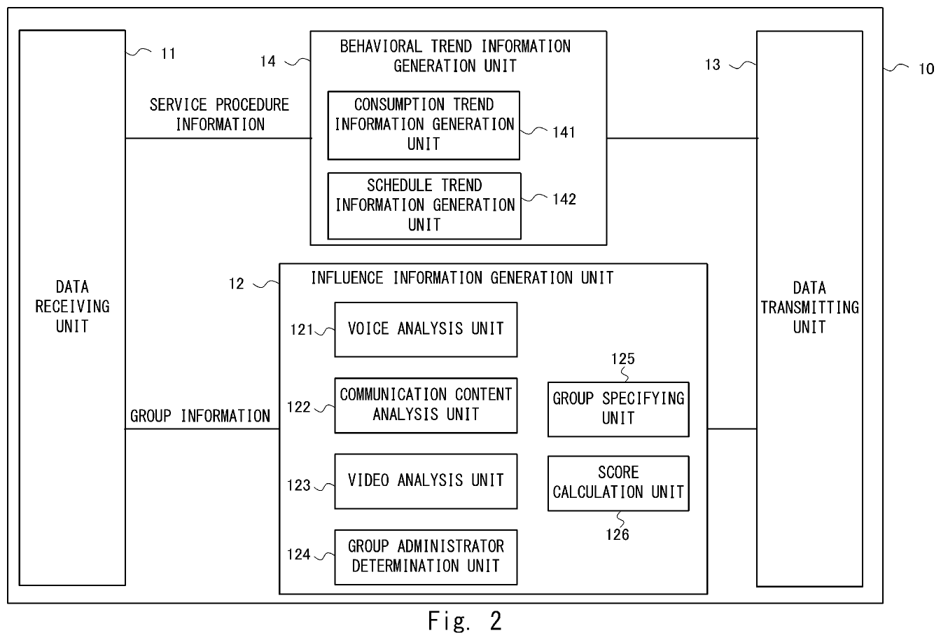

Next, details of an example embodiment will be described. FIG. 2 is a block diagram showing an example of a functional configuration of an information processing apparatus 10 according to an example embodiment. As shown in FIG. 2, the information processing apparatus 10 includes a data receiving unit 11, a behavioral trend information generation unit 14, an influence information generation unit 12, and a data transmitting unit 13. In this example embodiment, the information processing apparatus 10 is described as an apparatus for analyzing information about a group consisting of, as members, a plurality of inbound tourists visiting a specific country (e.g., Japan) and a behavioral trend of the inbound tourists. However, this apparatus is merely an example. That is, the members of the group do not have to be inbound tourists. Further, the persons of which the behavioral trend is analyzed do not have to be inbound tourists.

The data receiving unit 11 receives group information as described above. In this example embodiment, the data receiving unit 11 receives conversation information, SNS information, and video information as group information.

The conversation information is information about a voice call between members of the group. The conversation information is acquired, for example, by using a conversation information acquisition module incorporated in a terminal such as a smartphone used by a member. This module records a voice call between members and transmits information about the recorded voice to the information processing apparatus 10. Note that this module transmits the information about the recorded voice to the information processing apparatus 10, for example, together with information by which the member(s) or the terminal(s) can be identified. As described above, the conversation information is information about a history of calls.

The SNS (Social Networking Service) information is a message by using a text, an image or the like exchanged between members of the group on an SNS. That is, the SNS information is information about a history of messages.

As described above, each of the conversation information and the SNS information (message) is information about a history of communications exchanged between members belonging to the group.

Further, the SNS information includes information about an administrator of a group which has been created for enabling members to exchange messages therebetween. Specifically, the administrator information is information indicating who has created the group on a communication tool (i.e., an SNS application).

As described above, the SNS information includes the information about the administrator of the group created on the communication tool to enable members belonging to the group to perform communication therebetween.

The SNS information is acquired, for example, by using an SNS information acquisition module incorporated in a terminal such as a smartphone used by a member. This module acquires an operation log (i.e., information about a history of messages and administrator information) on the communication tool and transmits the acquired history information and the administrator information to the information processing apparatus 10. Note that this module transmits the acquired information to the information processing apparatus 10, for example, together with information by which the member(s) or the terminal(s) can be identified.

Note that the SNS information may be transmitted from a service provider of the SNS, i.e., a business operator who provides the communication tool to the information processing apparatus 10. In this case, the SNS information is transmitted from an apparatus such as a server managed by the business operator to the information processing apparatus 10.

The video information is image data obtained by shooting a movement of a group consisting of, as members, a plurality of persons belonging to the group. The video information may be image data of a still image or image data of a moving image. The video information is acquired, for example, by using a video information acquisition module incorporated in a terminal such as a smartphone used by a member. This module acquires image data taken by a camera provided in the terminal and transmits the acquired image data to the information processing apparatus 10. Note that this module transmits image data to the information processing apparatus 10, for example, together with information by which the member(s) or the terminal(s) can be identified. For example, the video information is image data that is obtained as the members take turns shooting the state of the group while they are walking. That is, it is possible to obtain the relative positions of the members while they are walking from the image data, which the members took turn to take and was transmitted to the information processing apparatus 10. In this example embodiment, as an example, the above-described relative positions are used to calculate scores of influences as described later. That is, a score of an influence is added to a person who is walking at the head of the group. Note that the influence of a member may be determined based on the video information by using other methods. For example, a score of an influence of a member may be calculated based on information about the lines of sight of members analyzed from the video information. That is, for example, a score of an influence may be added to a person who has attracted a largest number of attentions from other members. Note that the line of sight can be specified, for example, by detecting feature points around eyes such as inner corners of eyes, outer corners of eyes, and pupils by using a facial feature point detection technique. Alternatively, other methods for specifying a line of sight may be used. Further, the video information may be acquired from a camera installed on a street.

Further, the data receiving unit 11 receives service procedure information. Note that the service procedure information is data including information about a service received by an inbound tourist visiting a specific country and information indicating an attribute(s) of the inbound tourist. Note that the data receiving unit 11 receives, for example, service procedure information managed by an inbound service provider. That is, the data receiving unit 11 receives, for example, service procedure information that is transmitted from an apparatus such as a server managed by the inbound service provider to the information processing apparatus 10 through wired or wireless communication.

The data receiving unit 11 stores the received group information and the service procedure information in a storage device such as a memory 51 (which will be described later). The influence information generation unit 12 performs processing described later by using the group information stored in the storage device. Further, the behavioral trend information generation unit 14 performs processing described later by using the service procedure information stored in the storage device.

The influence information generation unit 12 generates influence information by analyzing the group information as described above. As shown in FIG. 2, the influence information generation unit 12 includes a voice analysis unit 121, a communication content analysis unit 122, a video analysis unit 123, a group administrator determination unit 124, a group specifying unit 125, and a score calculation unit 126.

The voice analysis unit 121 performs a voice recognition process on conversation information and thereby converts voice data into text data.

The communication content analysis unit 122 analyzes a history of communications such as a history of calls, which are converted into text by the voice analysis unit 121, and a history of messages of SNS information through a natural language processing. The communication content analysis unit 122 analyzes the communication history in accordance with predetermined evaluation items. For example, the communication content analysis unit 122 analyzes the number of utterances made by each member in calls, determines who is the member who has made the first or last utterance in a series of talks, analyzes the number of times of message transmissions by each member in the SNS, determines who has made an utterance or transmitted a message about a travel plan, and so on. Further, the communication content analysis unit 122 performs an analyzing process that is necessary for enabling the group specifying unit 125 to specify a group. Specifically, for example, the communication content analysis unit 122 analyzes, for example, whether or not the communication history includes a predetermined keyword. However, this is merely an example. That is, the communication content analysis unit 122 may perform other analyzing processes as the analyzing process necessary for enabling the group specifying unit 125 to specify a group.

The video analysis unit 123 performs an image recognition process on the video information and thereby determines who is walking at the head of the group while they are moving. The video analysis unit 123 determines who is walking at the head, for example, by determining the relative position of each member from each image data transmitted from the terminal of each member of the group. Further, the video analysis unit 123 performs an analyzing process necessary for enabling the group specifying unit 125 to specify a group. Specifically, for example, the video analysis unit 123 analyzes the number of members, the gender of each member, and the age of each member from the image data. However, this is merely an example. That is, the video analysis unit 123 may perform other analyzing processes as the analyzing process necessary for enabling the group specifying unit 125 to specify a group. Further, the number of members, the gender of each member, and the age of each member may be analyzed by the communication content analysis unit 122.

The group administrator determination unit 124 determines which of the members is the administrator of the group on the communication tool according to the administrator information included in the received SNS information.

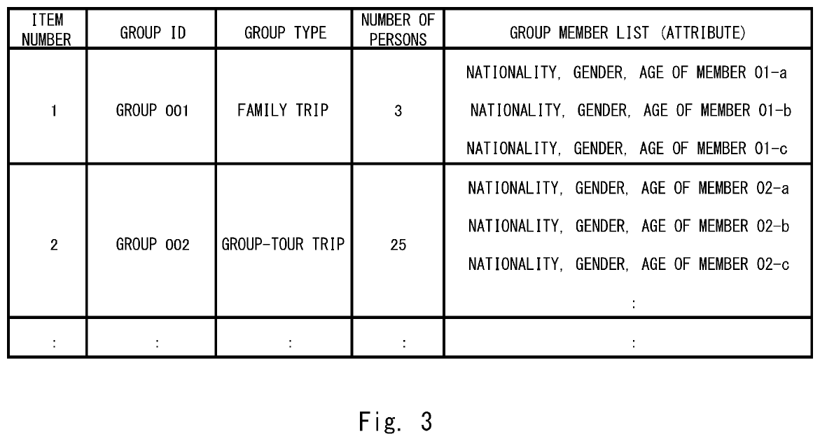

The group specifying unit 125 specifies a group based on the received group information. That is, the group specifying unit 125 generates, based on the group information, information for specifying a specific structure of the group in which influences are to be analyzed. This information includes an ID for identifying the group, a type of the group, the number of members, and a list of members of the group. FIG. 3 is a table showing an example of information generated by the group specifying unit 125.

Regarding the ID, the group specifying unit 125 assigns, for example, a serial number to each group. A specific example of the group type is a type of a travel such as a family trip or a group-tour trip. The group specifying unit 125 determines the group type based on, for example, the result of the analysis made by the communication content analysis unit 122.

Further, the group specifying unit 125 determines the number of members of the group based on, for example, the result of the analysis made by the video analysis unit 123. Note that the group specifying unit 125 may determine the number of members based on the communication history.

The group member list is information indicating attributes of each member. The attribute includes, for example, the nationality, the gender, and the age of each member. The group specifying unit 125 determines the nationality of each member based on, for example, the result of the analysis made by the communication content analysis unit 122. Specifically, the group specifying unit 125 determines the nationality of each member, for example, by determining the language used for their communication. Further, the group specifying unit 125 determines the gender and the age of each member, for example, based on the result of the analysis made by the video analysis unit 123. Note that the information indicating the attribute of each member is not limited to the above-described example, and may be the name of the member or information indicating a feature that can be recognized from the appearance of the member.

Note that in this example embodiment, the group specifying unit 125 generates information for specifying a specific structure of the group in which influences are to be analyzed by using the group information received by the data receiving unit 11. However, the group specifying unit 125 may specify the structure of the group by using other information. For example, the group specifying unit 125 may determine the number of members, the attributes of the members, and the like by using information related to the group and information about profiles of the members managed by the communication tool. In this case, the data receiving unit 11 receives the information related to the group and the information about the profiles of the members managed by the communication tool from a terminal(s) of a member(s) or a server of the SNS provider. Further, the group specifying unit 125 may specify a group by using information about a service procedure, such as information about a reservation of an airplane or an accommodation, received by the data receiving unit 11. In this case, for example, the group specifying unit 125 generates information for specifying the group by using various types of information such as names and the number of persons included in the reservation information. Note that in this case, the group specifying unit 125 extracts, by using, for example, the information which is received together with the group information by the data receiving unit 11 and by which members or terminals can be identified, only the reservation information related to those members from the reservation information received by the data receiving unit 11. Then, the group specifying unit 125 generates information for specifying the group by using the extracted reservation information.

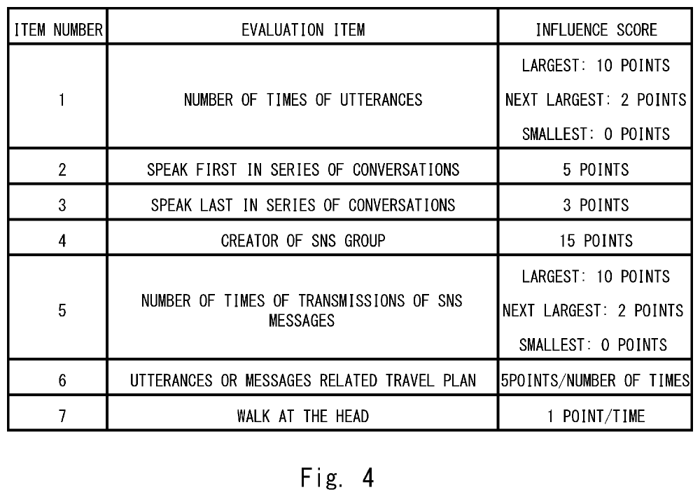

The score calculation unit 126 calculates a score of an influence of each member in the group specified by the group specifying unit 125 according to predetermined evaluation items. FIG. 4 is a table showing evaluation items used by the score calculation unit 126 and examples of scores for respective evaluation items. Note that the values of the scores shown in FIG. 4 are merely examples and the values of the scores used by the score calculation unit 126 are not limited to those shown in FIG. 4.

It is considered that the more frequently a member speaks, the larger influence that member has in the group. Therefore, according to the result of the analysis made by the communication content analysis unit 122, the score calculation unit 126 adds a value corresponding to the number of utterances as a score for that member. That is, the score calculation unit 126 adds a large score to a member having a large number of utterances. Note that in the example shown in FIG. 4, scores are added only to members having the largest number of utterances and the second largest number of utterances. However, scores may also be added to members having the third largest number of utterances and so on.

Further, it is considered that a member having a large influence in the group is likely to speak the first or last in a series of talks. Therefore, according to the result of the analysis made by the communication content analysis unit 122, the score calculation unit 126 adds a score having a predetermined value to the member who has spoken the first or last in a series of talks.

Further, it is considered that the creator (the administrator) of the SNS group i.e., the group on the communication tool has a large influence in the group. Therefore, the score calculation unit 126 adds a score having a predetermined value to the member who is the administrator of the group on the communication tool according to the result of the determination made by the group administrator determination unit 124.

Further, it is considered that the more frequently a member transmits messages, the larger influence that member has in the group. Therefore, according to the result of the analysis made by the communication content analysis unit 122, the score calculation unit 126 adds a value corresponding to the number of times of message transmissions as a score for that member. That is, the score calculation unit 126 adds a large score to a member having a large number of message transmissions. Note that in the example shown in FIG. 4, scores are added only to members having the largest number of message transmissions and the second largest number of message transmissions. However, scores may also be added to members having the third largest number of message transmissions and so on.

Further, it is considered that a member having a large influence in the group is likely to make an utterance or send a message about the travel plan. Therefore, according to the result of the analysis made by the communication content analysis unit 122, the score calculation unit 126 adds a score having a predetermined value to a member every time that member make an utterance or sends a message about the travel plan.

Further, it is considered that a member having a large influence in the group is likely to walk at the head of the group while they are moving. Therefore, the score calculation unit 126 adds a score having a predetermined value to the member who is walking at the head according to the result of the analysis made by the video analysis unit 123. Note that in the case where the image data analyzed by the video analysis unit 123 is a moving image, the score calculation unit 126 may add a score having a predetermined value to the member walking at the head in each unit time.

Note that the score calculation unit 126 may calculate a score according to an evaluation item other than the above-described evaluation items. For example, the score calculation unit 126 may add a score having a predetermined value to a member depending on whether or not the member is in charge of organizing the trip (e.g., the member under whose name an accommodation or the like is reserved). Note that whether or not a member is in charge of organizing the trip is determined by analyzing a communication history such as whether or not the member has made a remark or transmitted a message containing a specific keyword. Further, in this example embodiment, the score calculation unit 126 uses the relative position of each member while they are moving acquired from the video information for the calculation of scores. However, other information acquired from the video information may be used for the calculation of scores. For example, the way of walking, the walking speed, the clothes, or the like of each member acquired from the video information may be used for the calculation of scores.

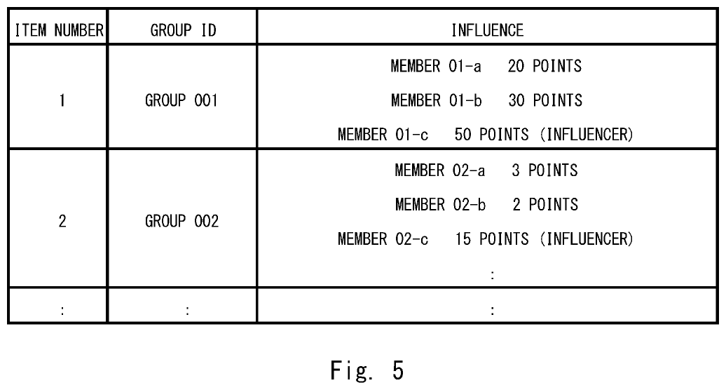

FIG. 5 is a table showing an example of results of calculation of scores for each member by the score calculation unit 126. In the example shown in FIG. 5, a “Member 01-c” has the highest score in a group having a group ID “Group 001”. Therefore, the score calculation unit 126 determines that the “Member 01-c” is an influencer in the group having the group ID “Group 001”. Similarly, a “Member 02-c” has the highest score in a group having a group ID “Group 002”. Therefore, the score calculation unit 126 determines that the “Member 02-c” is an influencer in the group having the group ID “Group 002”. Note that the influencer is a person who has an influence on a purchase decision in the group.

The score calculation unit 126 outputs the calculated score for each member as influence information to the data transmission unit 13. More specifically, the score calculation unit 126 uses information associating the identification information for identifying members and the scores as influence information. Note that the identification information associated with the score is, for example, information about the attributes of the group member list generated by the group specifying unit 125. Note that the influence information may not be the score of each member in the group, but may be the identification information of the member who has been determined as the influencer. Further, the influence information may be an index value representing the strength of the influence calculated based on the score.

As described above, the influence information generation unit 12 generates influence information by calculating a score of an influence of each member by using the information about a history of communications, the information about the administrator of the group in the communication tool, and the video information. Therefore, it is possible to make the actual relation among the members reflected in the score and thereby accurately estimate the influence of each member in the group. Note that in this example embodiment, the influence information generation unit 12 uses the information about a history of communications, the information about the administrator of the group in the communication tool, and the video information. However, the influence information generation unit 12 may generate the influence information by using only one of these information items. Further, the influence information generation unit 12 may generate the influence information by using any two of these information items. Further, the influence information generation unit 12 may generate the influence information by using other information in addition to these three information items.

As described above, in this example embodiment, since the influence information is generated, an influencer in the group can be easily specified. For example, an inbound service provider which has acquired influence information can conduct an efficient sales activity for the sales of commodities by approaching, among the members of the group, an influencer indicated in the influence information. Note that the sales activity means any of various types of activities related to sales, such as sales tasks, marketing, and sales promotion.

Next, the behavioral trend information generation unit 14 will be described. The behavioral trend information generation unit 14 generates behavioral trend information, which is data indicating a behavioral trend of an inbound tourist visiting a specific country, by analyzing service procedure information received by the data receiving unit 11. In this example embodiment, as shown in FIG. 2, the behavioral trend information generation unit 14 includes a consumption trend information generation unit 141 and a schedule trend information generation unit 142, and generates consumption trend information and schedule trend information as the behavioral trend information. The consumption trend information is data indicating a consumption trend of inbound travelers, i.e., a purchase trend of commodities. Further, the schedule trend information is data indicating a stay trend or a movement trend of inbound tourists. That is, the schedule trend information is data indicating a trend(s) as to when and where inbound tourists stay during their stays in a specific country.

As described above, the behavioral trend information generation unit 14 analyzes the service procedure information received by the data receiving unit 11. The service procedure information is data including information about a service received by an inbound tourist visiting a specific country (hereinafter referred to as service information) and information indicating an attribute(s) of the inbound tourist (hereinafter referred to as personal information). The service procedure information is, for example, information held by an inbound service provider. The service procedure information may include the whole information related to an inbound tourist (e.g., a foreign visitor to Japan). The service information is, for example, information about a service procedure carried out by an inbound tourist in a specific country, such as a type of a transaction, an amount of money of the transaction (i.e., a purchase price), an item to be sold/bought, a place where the transaction was carried out, and a date and time of the transaction. Therefore, the service information can also be regarded as information about a purchase of a commodity made by an inbound tourist visiting a specific country. Further, the personal information is information indicating an attribute(s) of a purchaser, and is, for example, information unique to an inbound tourist, such as passport information, the name, the nationality, the gender, the age, and the family structure of the inbound tourist.

For example, when the inbound service provider is a duty-free shop, the data receiving unit 11 of the information processing apparatus 10 receives, for example, the below-shown information as the service procedure information from an apparatus such as a server of the duty-free shop. That is, the data receiving unit 11 receives, as the service procedure information of which the type of the transaction is “tax exemption”, an item that a foreign visitor to Japan has purchased, an amount thereof, an amount of money of the transaction, information about the place of the duty free shop, information about the date and time of the tax-free transaction, and personal information of the purchaser.

The information processing apparatus 10 accumulates service procedure information transmitted from the inbound service provider. In this way, the information processing apparatus 10 collects a sufficient amount of service procedure information for performing a statistical analysis thereon. Then, the behavioral trend information generation unit 14 generates consumption trend information and schedule trend information by statistically analyzing the collected service procedure information. Therefore, the information processing apparatus 10 may include, for example, a database that stores service procedure information. For example, the data receiving unit 11 accumulates received service procedure information in the database, and the behavioral trend information generation unit 14 generates consumption trend information and schedule trend information by analyzing the service procedure information accumulated in the database.

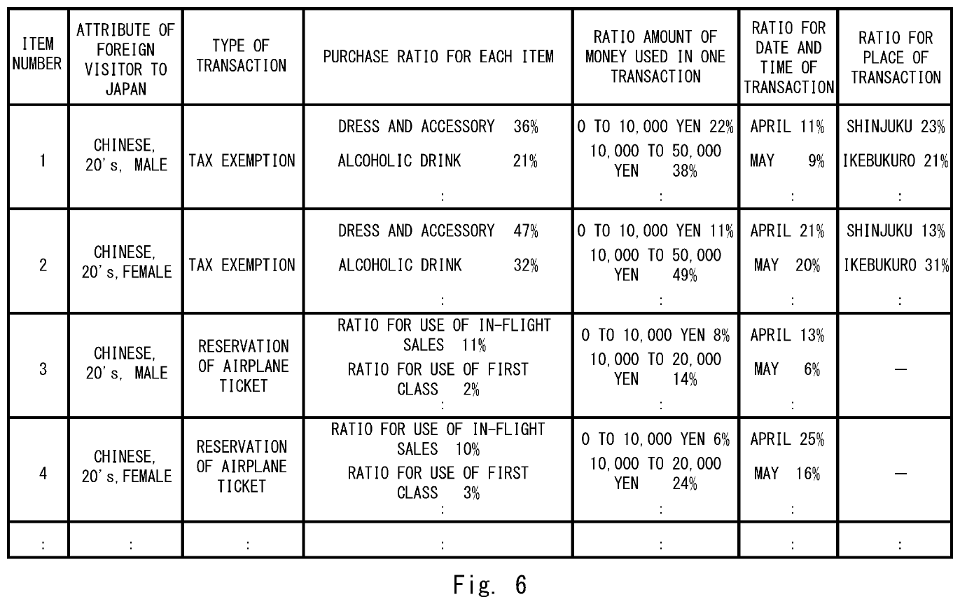

The consumption trend information generation unit 141 statistically analyzes the service procedure information and thereby generates, as the consumption trend information, data indicating a purchase trend of commodities according to the attribute of the inbound tourist (the attribute of the purchaser). FIG. 6 is a table showing an example of consumption trend information generated by the consumption trend information generation unit 141. Note that FIG. 6 shows, as an example, a purchase trend of Chinese males in their twenties and of that of Chinese females in their twenties for tax-free transactions, and a purchase trend of Chinese males in their twenties and that of Chinese females in their twenties for transactions related to reservations of airline tickets. Specifically, the consumption trend information generation unit 141 generates, as the purchase trend for tax-free transactions, information about a purchase ratio for each item, a ratio for an amount of money used in one transaction, a ratio for the date and time of the transaction (the month in which the transaction occurred), and a ratio for the place where the transaction occurred (the place of the store where the transaction occurred). Further, the consumption trend information generation unit 141 generates, as the purchase trend for transactions related to airline ticket reservations, information about a purchase ratio for each item (a ratio for use for each service), a ratio for an amount of money used in one transaction, and a ratio for the date and time of the transaction (the month in which the transaction occurred).

For example, when the consumption trend information indicates a trend of inbound tourists having an attribute X (e.g., an attribute specified by a nationality, an age, and a gender) indicating that they tend to purchase an item X1 at a time X2 in a place X3, it is possible to perform an efficient sales activity by distributing discount coupons for the purchase of the item X1 to inbound tourists having the attribute X at the time X2 in the place X3.

The schedule trend information generation unit 142 statistically analyzes service procedure information and thereby generates, as schedule trend information, data indicating a stay trend or a movement trend according to the attribute of the inbound tourist. The schedule trend information generation unit 142 generates schedule trend information according to the attribute of an inbound tourist by using information about a place related to a service received by the inbound tourist, included in the service procedure information. Note that the information about the place related to the service received by the inbound tourist is, for example, route information included in the service procedure information for the purchase of a ticket of transportation such as an airplane, a railroad, and a bus. In this example embodiment, the schedule trend information generation unit 142 generates data indicating the trend of the length of stay by using information about a date related to a service received by the inbound tourist in addition to the information about the place related to the service.

Note that as described above, the movement trend of inbound tourists can be analyzed by using the route information included in the service procedure information, which is the information about the purchase of a ticket of transportation. However, the movement trend may be analyzed by using other information. For example, the movement trend may be analyzed by using information about the place of a store included in the service procedure information for the purchase of commodities in the store as the information about the place related to the service and using information about the transaction date as the information about the date related to the service.

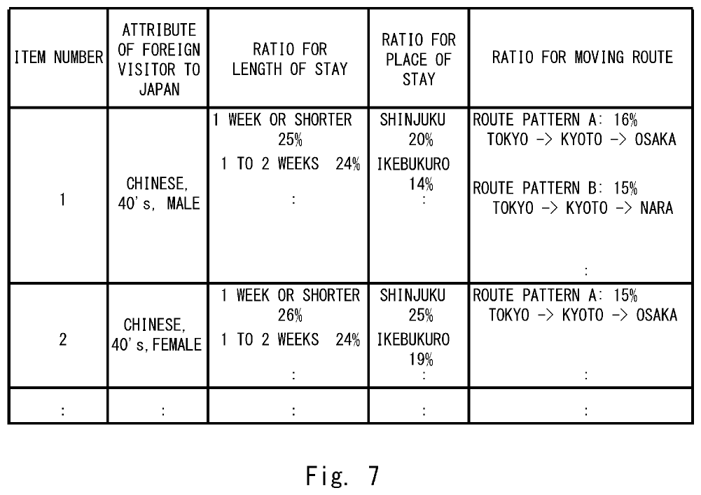

FIG. 7 is a table showing an example of schedule trend information generated by the schedule trend information generation unit 142. Note that FIG. 7 shows, as an example, a schedule trend of Chinese males in their forties and that of Chinese females in their forties. Specifically, the schedule trend information generation unit 142 generates information about a ratio for the length of stay and a ratio for the place of the stay in a specific country (e.g., Japan) as data of the stay trend, and generates information about a ratio for the pattern of a moving route as data of the movement trend.

By using the schedule trend information generated as described above, the inbound service provider can easily recognize the stay trend or the movement trend according to the attribute of the inbound tourist. Therefore, the inbound service provider can conduct an efficient sales activity according to the stay trend or the movement trend.

As described above, in this example embodiment, since information indicating a behavioral trend is generated, it is possible to support an efficient sales activity performed by an inbound service provider. Further, in particular, the information processing apparatus 10 can acquire service procedure information from a plurality of inbound service providers and thereby perform an analysis based on the acquired service procedure information. Therefore, it is possible to predict a trend with higher accuracy than the case where one inbound service provider independently analyzes a purchase trend.

The data transmission unit 13 transmits the influence information generated by the influence information generation unit 12 and the behavioral trend information generated by the behavioral trend information generation unit 14 to another apparatus(es). Specifically, for example, the data transmitting unit 13 transmits the influence information and the behavioral trend information to an apparatus of a business operator who provides commodities to customers, such as an inbound service provider, through wired or wireless communication. The data transmission unit 13 transmits the influence information and the behavioral trend information at an arbitrary timing determined in advance. For example, the data transmitting unit 13 may transmit the influence information at a timing when a service procedure is initiated by a member belonging to the group for which influence information is generated by the influence information generation unit 12. In this case, the data transmitting unit 13 transmits the influence information at a timing when the data receiving unit 11 receives service procedure information including information that can be associated with the member of the group (e.g., identification information of the member).

Next, operations performed by the information processing apparatus 10 will be described.

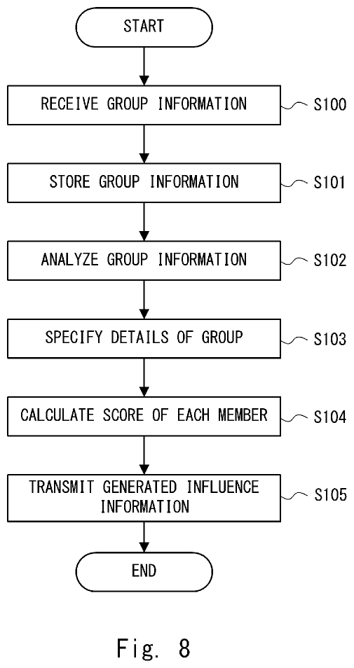

FIG. 8 is a flowchart showing an example of operations related to the generation of influence information in the information processing apparatus 10. The operations related to the generation of influence information in the information processing apparatus 10 will be described hereinafter with reference to FIG. 8.

Firstly, in a step 100 (S100), the data receiving unit 11 receives group information.

Next, in a step 101 (S101), the data receiving unit 11 stores the received group information in a storage device such as a memory 51 (which will be described later).

Next, in a step 102 (S102), the voice analysis unit 121, the communication content analysis unit 122, and the video analysis unit 123 analyze the group information. Further, the group administrator determination unit 124 specifies an administrator of the group on the communication tool.

Next, in a step 103 (S103), the group specifying unit 125 specifies details of the group in which influences are to be analyzed.

Next, in a step 104 (S104), the score calculation unit 126 calculates a score of an influence of each member of the group specified by the group specifying unit 125, and thereby generates influence information.

Next, in a step 105 (S105), the data transmitting unit 13 transmits the generated influence information to another apparatus(es).

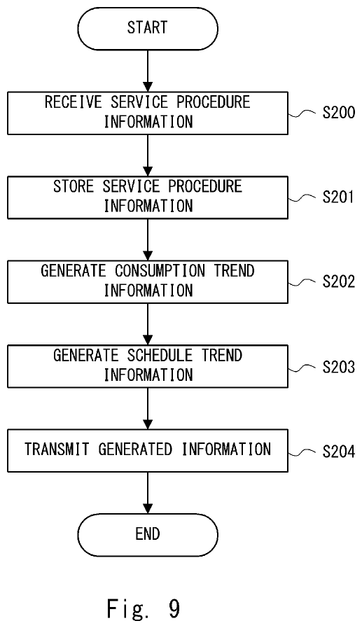

FIG. 9 is a flowchart showing an example of operations related to the generation of behavioral trend information in the information processing apparatus 10. The operations related to the generation of behavioral trend information in the information processing apparatus 10 will be described hereinafter with reference to FIG. 9.

Firstly, in a step 200 (S200), the data receiving unit 11 receives service procedure information.

Next, in a step 201 (S201), the data receiving unit 11 stores the received service procedure information in a storage device (a database) such as a memory 51 (which will be described later).

Next, in a step 202 (S202), the consumption trend information generation unit 141 generates consumption trend information based on the service procedure information.

Next, in a step 203 (S203), the schedule trend information generation unit 142 generates schedule trend information based on the service procedure information.

Next, in a step 204 (S204), the data transmission unit 13 transmits the generated consumption trend information and the schedule trend information to another apparatus(es).

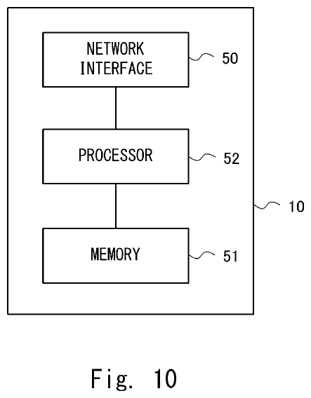

Next, a hardware configuration of the information processing apparatus 10 will be described. FIG. 10 is a block diagram showing an example of a hardware configuration of the information processing apparatus 10. As shown in FIG. 10, it includes, for example, a network interface 50, a memory 51, and a processor 52.

The network interface 50 is used to communicate with other apparatuses through a wired or wireless network. The network interface 50 may include, for example, a network interface card (NIC). The data receiving unit 11 and the data transmitting unit 13 transmit and receive data through the network interface 50.

The memory 51 is formed by a combination of a volatile memory and a nonvolatile memory. The memory 51 may include a storage remotely disposed from the processor 52. In this case, the processor 52 may access the memory 51 through an input/output interface (not shown).

The memory 51 is used to store software (a computer program) including at least one instruction executed by the processor 52.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Further, the memory 51 may be used as a storage device that stores group information and service procedure information received by the data receiving unit 11.

The processor 52 loads software (a computer program) from the memory 51 and execute the loaded software, thereby performing the processing of each component shown in FIG. 2. As described above, the information processing apparatus 10 has functions as a computer. The processor 52 may be, for example, a microprocessor, an MPU (Micro Processor Unit), or a CPU (Central Processing Unit). The processor 52 may include a plurality of processors.

Note that the present invention is not limited to the above-described example embodiments and can be modified as appropriate without departing from the scope and spirit of the disclosure. For example, the data receiving unit 11 may receive information used by the behavioral trend information generation unit 14 from other kinds of business operators as well as from the inbound service providers. For example, behavioral trend information may be generated by using information received from a business operator who manages information about visas of foreign visitors to Japan. Further, the behavioral trend information generation unit 14 may generate not only behavioral trend information according to the attribute of the inbound tourist, but also behavioral trend information according to the length of stay of the inbound tourist. In this way, for example, it becomes possible to recognize a behavioral trend such as a trend indicating that a foreign visitor to Japan who stays in Japan for one week or longer tends to purchase a large amount of jewelry. Further, the behavioral trend information generation unit 14 may generate information about a behavioral trend other than the consumption trend or the schedule trend. For example, the behavioral trend information generation unit 14 may generate, based on service procedure information about a package tour including participation in a predetermined event (e.g., a snow festival) held in Japan, sold by a travel agency, information indicating a trend of participation of foreign visitors to Japan in the predetermined event.

Although the present invention is explained above with reference to example embodiments, the present invention is not limited to the above-described example embodiments. Various modifications that can be understood by those skilled in the art can be made to the configuration and details of the prevent invention within the scope of the invention.

This application is based upon and claims the benefit of priority from Japanese patent application No. 2018-008050, filed on Jan. 22, 2018, the disclosure of which is incorporated herein in its entirety by reference.

### REFERENCE SIGNS LIST

10 INFORMATION PROCESSING APPARATUS
11 DATA RECEIVING UNIT
12 INFLUENCE INFORMATION GENERATING UNIT
13 DATA TRANSMISSION UNIT
14 BEHAVIORAL TREND INFORMATION GENERATION UNIT
50 NETWORK INTERFACES
51 MEMORY
52 PROCESSOR
121 VOICE ANALYSIS UNIT
122 COMMUNICATION CONTENT ANALYSIS UNIT
123 VIDEO ANALYSIS UNIT
124 GROUP ADMINISTRATOR DETERMINATION UNIT
125 GROUP SPECIFYING UNIT
126 SCORE CALCULATION UNIT
141 CONSUMPTION TREND INFORMATION GENERATION UNIT
142 SCHEDULE TREND INFORMATION GENERATION UNIT

What is claimed is:

1. An information processing apparatus comprising:
at least one memory storing program instructions; and
at least one processor configured to execute the instructions stored in the memory to:
receive group information, the group information being data about a group consisting of, as members, a plurality of persons;
generate influence information by analyzing the received group information, the influence information being data indicating a degree of influence of a member belonging to the group on another member belonging to the group; and
transmit the generated influence information to another apparatus.

2. The information processing apparatus according to claim 1, wherein
the processor is further configured to execute the instructions stored in the memory to:
receive service procedure information, the service procedure information being data including information about a service received by a person and information indicating an attribute of the person; and
generate behavioral trend information by analyzing the received service procedure information, the behavioral trend information being data indicating a trend of behavior of persons.

3. The information processing apparatus according to claim 1, wherein
the group information includes information about a history of communications exchanged between members belonging to the group, and
the processor is further configured to execute the instructions stored in the memory to generate he influence information by calculating a score of an influence of each of the members by using the history information.

4. The information processing apparatus according to claim 1, wherein
the group information includes information about an administrator of a group that is created on a communication tool to enable members belonging to the group to perform communication therebetween, and
the processor is further configured to execute the instructions stored in the memory to generate the influence information by calculating a score of an influence of each of the members by using the administrator information.

5. The information processing apparatus according to claim 1, wherein
the group information includes video information obtained by shooting a movement of a group consisting of a plurality of members belonging to the group, and
the processor is further configured to execute the instructions stored in the memory to generate the influence information by calculating a score of an influence of each of the members by using the video information.

6. The information processing apparatus according to claim 2, wherein
the service procedure information includes information about purchase of a commodity and information indicating an attribute of a purchaser, and
the behavioral trend information is data indicating a purchase trend of a commodity according to the attribute.

7. The information processing apparatus according to claim 2, wherein
the service procedure information includes information about a place related to a service received by a person, and
the behavioral trend information is data indicating a stay trend or a movement trend according to an attribute of a person.

8. An analysis method, wherein an information processing apparatus:
receives group information, the group information being data about a group consisting of, as members, a plurality of persons;
generates influence information by analyzing the received group information, the influence information being data indicating a degree of influence of a member belonging to the group on another member belonging to the group; and
transmits the generated influence information to another apparatus.

9. A non-transitory computer readable medium storing a program for causing a computer to perform:
a data receiving step of receiving group information, the group information being data about a group consisting of, as members, a plurality of persons;
an influence information generation step of generating influence information by analyzing the received group information, the influence information being data indicating a degree of influence of a member belonging to the group on another member belonging to the group; and
a data transmitting step of transmitting the generated influence information to another apparatus.
